(19) United States
(12) Patent Application Publication
(10) Pub. No.: US 2018/0341051 A1
(43) Pub. Date: Nov. 29, 2018

(54) LED LIGHT-INCIDENT METHOD OF EDGE-LIT BACKLIGHT MODULE

(71) Applicant: SHENZHEN CHINA STAR OPTOELECTRONICS TECHNOLOGY CO., LTD., Shenzhen, Guangdong (CN)

(72) Inventor: Lixuan Chen, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 15/329,378

(22) PCT Filed: Jan. 16, 2017
(86) PCT No.: PCT/CN2017/071285

§ 371 Date: Nov. 9, 2017

(30) Foreign Application Priority Data
Dec. 27, 2016 (CN) 201611224581.2

(51) Int. Cl. F21V 8/00

(52) U.S. Cl. CPC G02B 6/003; G02B 6/0068; G02B 6/0088

(57) ABSTRACT

Disclosed is an LED light-incident method of an edge-lit backlight module. Light emitted by an is converged by a lens or a lens group that is arranged between the LED and a light guide structure, and then enters the light guide structure. When a thickness of the LED is larger than that of the light guide structure, the light emitted by the LED can completely enter the light guide structure after being converged, so that requirement of reducing a thickness of the light guide structure can be satisfied, and meanwhile light utilization efficiency can be ensured.

### CROSS-REFERENCE TO RELATED APPLICATIONS

This application claims the priority of Chinese patent application CN 201611224581.2, entitled “LED light-incident method of edge-lit backlight module” and filed on Dec. 27, 2016, the entirety of which is incorporated herein by reference.

### FIELD OF THE INVENTION

The present disclosure relates to the technical field of liquid crystal display, and in particular, to an LED light-incident method of an edge-lit backlight module.

### BACKGROUND OF THE INVENTION

With many advantages such as small thickness, low power consumption, and low radiation, liquid crystal display (LCD) device has been widely used. Most LCD devices in the market are backlight LCD devices, which comprise a liquid crystal panel and a backlight module. In general, a liquid crystal display panel comprises a color filter substrate, a thin film transistor (TFT) array substrate, liquid crystal (LC) filled between the color filter substrate and the TFT array substrate, and a sealant.

The working principle of the liquid crystal panel lies in that: liquid crystal molecules are placed between two parallel glass substrates, and orientation directions of the liquid crystal molecules are changed through providing electric power to the glass substrates so as to display an image by reflecting light emitted by a backlight module. Since the liquid crystal panel itself does not emit light, it is necessary to display the image normally by a light source provided by the backlight module. Therefore, the backlight module is one of key components of the LCD device.

The backlight module, based on different locations of a light source, can be divided into two types, i.e., an edge-lit backlight module and a direct-lit backlight module, in the direct-lit backlight module, the light source such as a cold cathode fluorescent lamp (CCFL) or a light emitting diode (LED) is arranged behind the liquid crystal panel to form a planar light source directly, which is provided to the liquid crystal panel. In the edge-lit backlight module, a backlight LED light bar is arranged on an edge of a backplane of a rear side of the liquid crystal panel. Light emitted by the LED light bar enters a light guide plate (LGP) from a light-incident surface on one side thereof, then emits from a light emitting surface of the light guide plate after reflection and diffusion, and then forms a planar light source via an optical diaphragm group, which is provided to the liquid crystal panel. In the edge-lit backlight module, the LED light bar is arranged on a lateral surface of the light guide plate, so that a thickness of the backlight module is quite small. Hence, the edge-lit backlight module is widely used in LCD device, as shown in FIGS. 1 to 3 (which are cross sectional views of three ultra-thin edge-lit LCD backlight modules).

Nowadays, ultra-thin display device has become a hotspot in the market. One of core works of engineers is how to make thicknesses of display devices such as mobile phones and televisions smaller. However, a size of the LED is limited by efficiency requirements. The smaller the size is, requirements of power consumption and brightness are less likely to be met. When a thickness of the glass substrate continues to decrease, for example, the thickness is 0.4 mm, or a flexible organic material substrate (a thickness is in a range from 10 to 200 μm) is used as a light guide structure, or a thinner independent glass light guide plate is used as a light guide structure, a situation that the size of the used LED may exceed a thickness of the light guide structure should be considered, as shown in FIG. 4. When the LED size is larger than a size of a cross section of the light guide plate or other light guide structure, light emitted by the LED cannot completely enter the light guide structure, and light loss is serious.

In order to reduce light loss, the method that the light emitted by the LED enters the light guide structure has become a problem to be solved urgently.

### SUMMARY OF THE INVENTION

Aiming at the disadvantages in the prior art, the present disclosure provides an LED light-incident method of an edge-lit backlight module. According to this method, even if a size of an LED is larger than a thickness of a light guide structure, light emitted by the LED can completely enter the light guide structure, so that requirement of reducing the thickness of the light guide structure can be satisfied, and meanwhile light utilization efficiency can be ensured.

The present disclosure provides an LED light-incident method of an edge-lit backlight module. Light emitted by an LED is converged by a lens or a lens group that is arranged between the LED and a light guide structure, and then enters into the light guide structure.

According to some embodiments of the present disclosure, the lens is a convex lens.

According to some embodiments of the present disclosure, the lens is a glass lens and/or a plastic lens.

According to the present disclosure, when a plurality of LEDs are provided, one lens is arranged between the light guide structure and the plurality of LEDs, or one lens or one lens group is arranged between the light guide structure and each of the plurality of LEDs.

According to some embodiments of the present disclosure, all lenses or lens groups arranged between the light guide structure and each of a plurality of LEDs are manufactured on an organic film to form an integrated structure, which is then fixed through a mechanical method between the LEDs and the light guide structure.

According to some embodiments of the present disclosure, the lenses are manufactured on one side or two sides of the organic film.

According to some embodiments of the present disclosure, the organic film is a plastic film, and has one layer or more layers.

According to the present disclosure, the lens between the LED and the light guide structure is bonded to a light-incident side of the light guide structure or a light-emitting surface of the LED.

According to some embodiments of the present disclosure, bonding is realized by an adhesive.

Compared with the prior art, one embodiment or more embodiments of the above solutions can have following advantages or beneficial effects.

According to the present disclosure, the light emitted by the LED is converged by the lens or the lens group that is arranged between the LED and the light guide structure, and then enters into the light guide structure. In this manner, when a thickness of the LED is larger than that of the light guide structure, the light emitted by the LED can completely enter the light guide structure after being converged, so that requirement of reducing the thickness of the light guide structure can be satisfied, and meanwhile light utilization efficiency can he ensured. Besides, complexity of a lens system can be reduced by manufacturing separate lenses or lens groups into an integrated structure, or bonding the lens to the light-incident side of the light guide structure or the light-emitting surface of the LED.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIGS. 1 to 3 are cross sectional views of three ultra-thin edge-lit LCD backlight modules in the prior art, in which, FIG. 1 is a cross sectional view of a first ultra-thin edge-lit LCD backlight module, FIG. 2 is a cross sectional view of a second ultra-thin edge-lit LCD backlight module, and FIG. 3 is a cross sectional view of a third ultra-thin edge-lit LCD backlight module;

FIG. 4 schematically shows a diagram that light emitted by an LED cannot completely enter a light guide structure when a thickness of the LED is larger than that of the light guide structure;

FIG. 5 schematically shows a single lens arranged between the LED and the light guide structure;

FIG. 6 schematically show a lens group arranged between the LED and the light guide structure;

FIG. 7 schematically shows a structure that one lens is arranged between the light guide structure and each of a plurality of LEDs;

FIG. 8 schematically shows a structure that one lens is arranged between the light guide structure and a plurality of LEDs;

FIG. 9 schematically shows an integrated structure arranged between the LED and the light guide structure, which is provided with lenses on one side thereof;

FIG. 10 schematically shows an integrated structure arranged between the LED and the light guide structure, which is provided with lenses on two sides thereof;

FIG. 11 schematically shows that lenses between the LED and the light guide structure are bonded to a light-emitting surface of the LED;

FIG. 12 schematically shows that a plurality of lenses between the LED and the light guide structure are bonded to a light-incident side of the light guide structure;

FIG. 13 schematically shows that one single lens is bonded to the light-incident side of the light guide structure; and

FIG. 14 is a side view of FIG. 13.

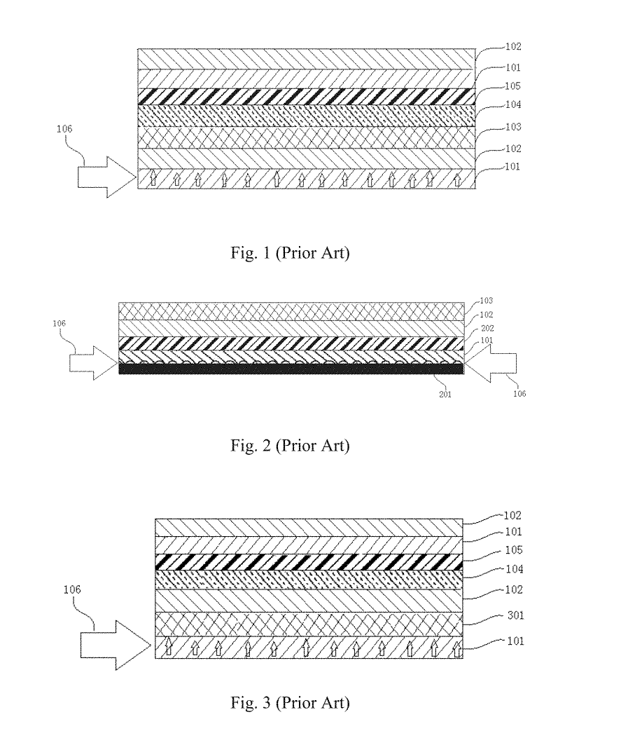

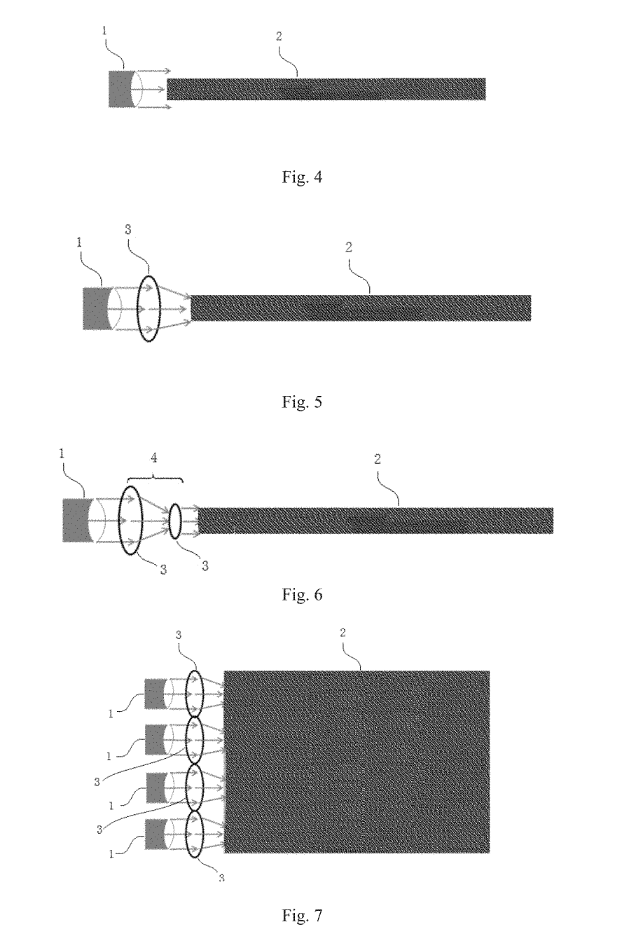

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no conflict, all the technical features mentioned in all the embodiments may be combined together in any manner, and the technical solutions obtained in this manner all fall within the scope of the present disclosure.

As described hereinbefore, ultra-thin display devices are widely used, and a thickness of a light guide structure decreases continually. When a size of the light guide structure is smaller than that of an LED, light emitted by the LED cannot completely enter the light guide structure, and light loss is quite serious. A lens can change transmission paths of light and converge the light. The light emitted by the LED can be converged by a lens or a lens group arranged between the LED and a light guide structure, and then enters the light guide structure. Therefore, requirement of reducing the thickness of the light guide structure can be satisfied and meanwhile the light loss can be effectively reduced.

FIGS. 5 to 13 schematically show structures of arranging a lens or a lens group between an LED and a light guide structure according to some embodiments of an LED light-incident method of an edge-lit backlight module in the present disclosure.

As shown in FIG. 5, one single lens is arranged between the LED and the light guide structure, and the light emitted by the LED is converged and then enters the light guide structure. As to the single lens, a type of the light entering into the light guide structure can be adjusted by adjusting a focal length of the lens, and a distance between the lens and the light guide structure/a light-emitting surface of the LED.

The lens is a convex lens.

The lens is a glass lens and/or a plastic lens. Preferably, the lens is a plastic lens.

When a distance between the LED and the light guide structure is quite large, a lens group (i.e., two or more lenses arranged in a longitudinal direction between the LED and the light guide structure) can be arranged between the LED and the light guide structure, and the light emitted by the LED is converged and then enters the light guide structure, as shown in FIG. 6. As to the lens group structure, focal lengths of the lenses and positional relationship among different lenses can be adjusted, so that the emitted light can better enter the light guide structure.

The lens in the lens group is a convex lens.

The lens in the lens group is a glass lens and/or a plastic lens. Preferably, the lens is a plastic lens.

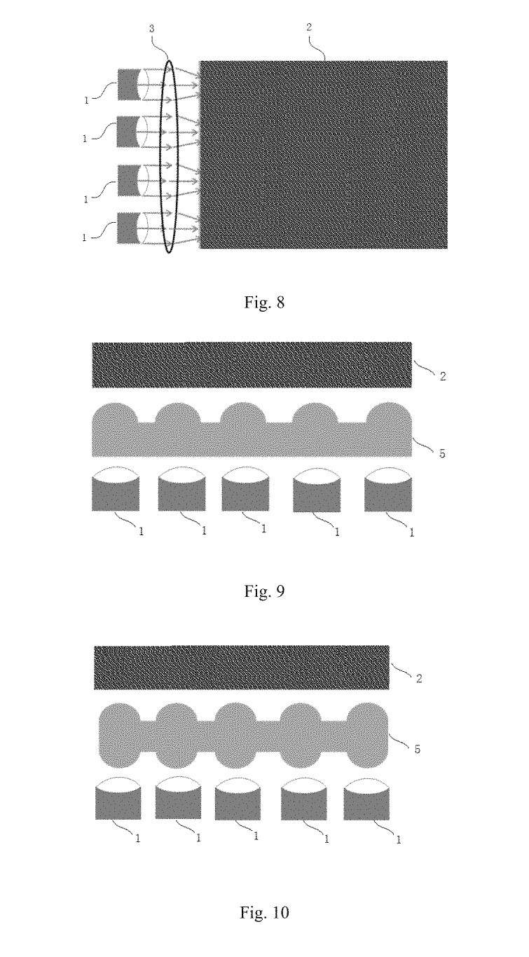

When a plurality of LEDs are provided, one elongated large lens is arranged between the light guide structure and the plurality of LEDs, as shown in FIG. 8; or one lens is arranged between the light guide structure and each of the plurality of LEDs, as shown in FIG. 7; or one lens group is arranged between the light guide structure and each of the plurality of LEDs, and the light emitted by the LED is converged and then enters the light guide structure.

All lenses or lens groups arranged between the light guide structure and each of a plurality of LEDs are manufactured on an organic film to form an integrated structure, which is then fixed through a mechanical method between the LEDs and the light guide structure, and the light emitted by the LED is converged and then enters the light guide structure. The mechanical method can be screw fixing, groove fixing, tape fixing, and so on.

The lens can be arranged on one side of an organic film, as shown in FIG. 9, and the lens can also be arranged on two sides of the organic film, as shown in FIG. 10.

The organic film is a plastic film, and has one layer or more layers.

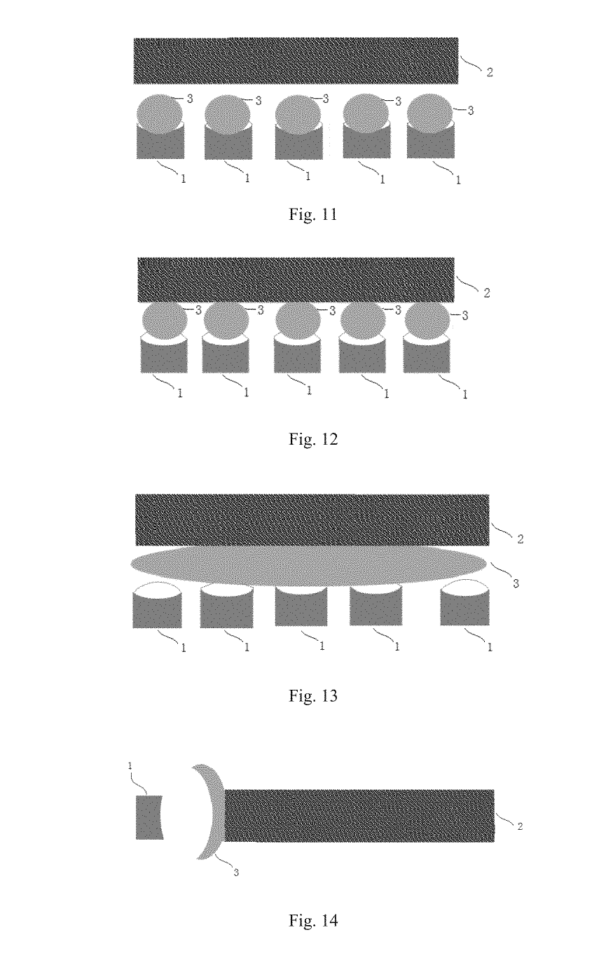

The lens between the LED and the light guide structure is bonded to a light-emitting surface of the LED, and the light emitted by the LED is converged and then enters the light guide structure, as shown in FIG. 11. Bonding is realized by an adhesive.

A plurality of lenses between the LED and the light guide structure are bonded to a light-incident side of the light guide structure, and the light emitted by the LED is converged and then enters the light guide structure, as shown in FIG. 12. Bonding is realized by an adhesive.

The single elongated large lens between the LED and the light guide structure is bonded to the light-incident side of the light guide structure, and the light emitted by the LED is converged and then enters the light guide structure, as shown in FIG. 13. FIG. 14 is a side view of the structure. Bonding is realized by an adhesive.

In conclusion, according to the present disclosure, the light emitted by the LED is converged by the lens or the lens group that is arranged between the LED and the light guide structure, and then enters into the light guide structure. In this manner, when a thickness of the LED is larger than that of the light guide structure, the light emitted by the LED can completely enter the light guide structure after being converged, so that requirement of reducing the thickness of the light guide structure can be satisfied, and meanwhile light utilization efficiency can be ensured. Besides, complexity of a lens system can be reduced by manufacturing separate lenses or lens groups into an integrated structure, or bonding the lens to the light-incident side of the light guide structure or the light-emitting surface of the LED.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

### LIST OF REFERENCE NUMBERS

101—Glass substrate;

102—Polarizer;

103—Color filter substrate;

104—Liquid crystal layer;

105—Array substrate;

106—LED light;

201—Reflection sheet;

202—Refractive layer;

301—Indium tin oxide color filter substrate;

1—LED light source;

2—Light guide structure;

3—Lens;

4—Lens group; and

5—Integrated structure.

1. An LED light-incident method of an edge-lit backlight module, wherein light emitted by an LED is converged by a lens or a lens group that is arranged between the LED and a light guide structure, and then enters the light guide structure.

2. The LED light-incident method according to claim 1, wherein the lens is a convex lens.

3. The LED light-incident method according to claim 1, wherein the lens is a glass lens and/or a plastic lens.

4. The LED light-incident method according to claim 1, wherein the lens is a plastic lens.

5. The LED light-incident method according to claim 1, wherein when a plurality of LEDs are provided, one lens is arranged between the light guide structure and the plurality of LEDs, or one lens or one lens group is arranged between the light guide structure and each of the plurality of LEDs.

6. The LED light-incident method according to claim 4, wherein all lenses or lens groups arranged between the light guide structure and each of a plurality of LEDs are manufactured on an organic film to form an integrated structure, which is then fixed through a mechanical method between the LEDs and the light guide structure.

7. The LED light-incident method according to claim 6, wherein the lenses are manufactured on one side or two sides of the organic film.

8. The LED light-incident method according to claim 6, wherein the organic film is a plastic film.

9. The LED light-incident method according to claim 6, wherein the organic film has one layer or more layers.

10. The LED light-incident method according to claim 1, wherein the lens between the LED and the light guide structure is bonded to a light-incident side of the light guide structure or a light-emitting surface of the LED.

11. The LED light-incident method according to claim 10, wherein bonding is realized by an adhesive.
